(19) United States
(12) Patent Application Publication
(10) Pub. No.: US 2003/0141959 A1
(43) Pub. Date: Jul. 31, 2003

(54) Fingerprint biometric lock

(76) Inventors: Colin Robert Keogh, Casselberry, FL (US); Kyle Dana Keogh, Lake Mary, FL (US)

Correspondence Address: SCOTT L. TERRELL, P.C., SUITE 225, 1746 COLE BLVD., GOLDEN, CO, 80401, US

(21) Appl. No.: 10/358,013

(22) Filed: Feb. 4, 2003

Related U.S. Application Data
(63) Continuation-in-part of application No. 10/185,453, filed on Jun. 28, 2002.
(60) Provisional application No. 60/302,154, filed on Jun. 29, 2001.

(51) Int. Cl. G06F 7/04

(52) U.S. Cl. 340/5.53

(57) ABSTRACT

A fingerprint biometric lock is provided which includes a locking mechanism that restricts the movement of an object that is to be unlocked, a movement restriction electronic circuit that restricts the unlocking of the object by the locking mechanism, a fingerprint sensor that detects a fingerprint pattern, a memory device that stores an enrolled fingerprint code data, a verifying unit that determines whether an offered fingerprint code, created from the fingerprint pattern sensed by the sensor, matches with any of the enrolled fingerprint codes stored in the memory device, a motor control unit that unlocks the locking mechanism through the movement restricting electronic circuit, when the offered and enrolled fingerprint codes match, and, a finger presence detector for powering a direct current to the sensor and the motor control unit.

### CROSS REFERENCE TO RELATED APPLICATIONS

Continuation-in-part of U.S. application Ser. No. 10/185,453, filed Jun. 28, 2002 which claims the benefit, pursuant to 35 U.S.C. 119(e), of U.S. Provisional Application Ser. No. 60,302,154, filed Jun. 29, 2001.

### BACKGROUND OF THE INVENTION

1. Field of the Invention

The present invention relates to safe storage systems. In particular, it relates to biometric locking systems.

2. Description of the Related Art

It is well known that rapid access to highly secured storage systems, such as gun safes and the like, is hampered when the system is secured using a keyed lock. It is also known that keys are easily misplaced, copied, and keyed locks are easily picked or drilled. Moreover, keyed locks do not limit access to a particular individual. A solution is to provide a fingerprint matching system that detects fingerprints and compares them with fingerprint data stored in a database for locking or unlocking safe storage systems.

Up to now a few such examples exist. For example, U.S. Pat. No. 5,579,909, to Deal, and U.S. Pat. No. 5,701,770, to Cook et al., disclose optical fingerprint readers combined with either a numeric keypad or fingerprint card backup access controls, respectively. Another example, U.S. Pat. No. 4,768,021, to Ferraro, discloses a pressure sensitive touch pad for access to a gun safe. A third such example, E.P. Pat. No. 0,976,897 A1, to Saito, discloses a lock and switch using a pressure-type fingerprint sensor. A fourth such example, U.S. Pat. No. 5,794,466, to Hungerford, et al., discloses a gun safe using a fingerprint access method with a mechanical override.

While the foregoing examples offer some utility, a major disadvantage in the use of backup systems or mechanical overrides is that they circumvent the added security a fingerprint sensor provides by adding devices which are more easily defeated. Another disadvantage with each of the foregoing examples, is that they do not incorporate power management circuits for extending battery life when the fingerprint sensors are used in portable applications.

While the foregoing examples provide for safe storage access systems, there is still a need for an improved biometric locking system which is useful in either fixture or portable highly secure storage applications. Our invention satisfies these needs.

### BRIEF SUMMARY OF THE INVENTION

It is therefore a principal object of the present invention to provide a biometric locking system which allows for rapid and easy access of it's authorized users, but cannot be easily overridden.

It is another object of the invention to provide a versatile biometric locking system which is useful in either fixture or portable highly secure applications.

To overcome the problems of the prior art and in accordance with the purpose of the invention, as embodied and broadly described herein, briefly, a fingerprint biometric lock is provided which includes a locking mechanism that restricts the movement of an object that is to be unlocked, a movement restriction electronic circuit that restricts the unlocking of the object by the locking mechanism, a fingerprint sensor that detects a fingerprint pattern, a memory device that stores an enrolled fingerprint code data, a verifying unit that determines whether an offered fingerprint code, created from the fingerprint pattern sensed by the sensor, matches with any of the enrolled fingerprint codes stored in the memory device, a motor control unit that unlocks the locking mechanism through the movement restricting electronic circuit, when the offered and enrolled fingerprint codes match, and, a finger presence detector for powering a direct current to the sensor and the motor control unit.

Additional advantages of the present invention will be set forth in part in the description that follows and in part will be obvious from that description or can be learned from practice or testing of the invention. The advantages of the invention can be realized and obtained by the apparatus and methods particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention.

FIG. 1 is a diagram showing the power management to the biometric locking system for use in either in either fixture or portable highly secure applications.

FIG. 2 is a flow chart showing the enrollment steps for enabling a valid fingerprint for access to the biometric locking system.

FIG. 3 is a flow chart showing an embodiment for single step enrollment for enabling a valid fingerprint for access to the biometric locking system.

FIG. 4 is a flow chart showing an alternative embodiment of a three step enrollment for enabling a valid fingerprint for access to the biometric locking system.

FIG. 5 is a flow chart showing the preferred steps for verifying an enabled fingerprint and powering the unlocking mechanism for access to the object to be secured.

FIG. 6 is a flow chart showing the preferred steps for deleting an enabled fingerprint for removing access to the object to be secured.

FIG. 7 is a flow chart showing the preferred steps for extending battery life when wall and battery power are applied.

FIG. 8 is a diagram of the control board according to the preferred embodiment of the present invention.

FIG. 9 is schematic bottom view drawing of a highly secure portable gun safe which is accessed using the fingerprint biometric lock according to the present invention.

FIG. 10 is a side view of the gun safe shown in FIG. 9.

### DETAILED DESCRIPTION OF THE DRAWINGS

Unless specifically defined otherwise, all technical or scientific terms used herein have the same meaning as commonly understood by one of ordinary skill in the art to which this invention belongs.

Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings.

A controller card is provided to unlock the lock using a fingerprint scanning module. The controller implements all functions for enrolling, canceling enrolls and verification of valid fingerprints.

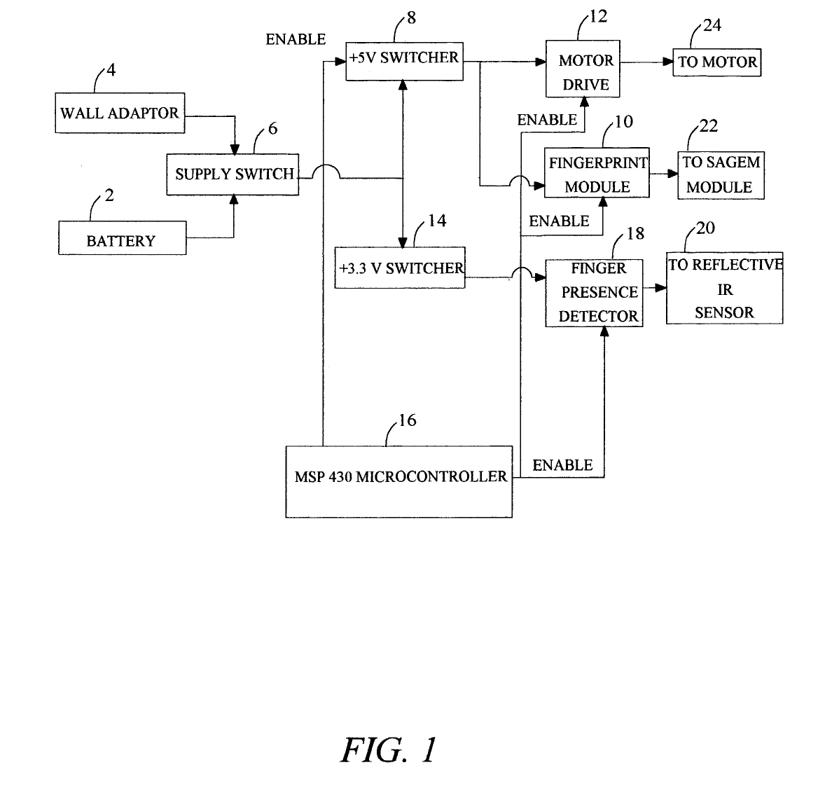

Referring now to FIG. 1, there is generally shown therein a diagram of the locking hardware according to the present invention. The hardware is controlled via a power management system, which enhances the durability of the fingerprint biometric lock when used with either fixture or portable storage applications. The lock is powered with a direct current voltage source 2, such as three internal dry cells, in a conventional direct current circuit. An external wall adapter 4 may, but need not, be provided for an alternating current power circuit in order to either prolong battery life, or for operation of the lock once the batteries have expired. An automatic transfer switch 6 on the input of both power supplies is then included to constantly monitor the direct 2 and alternating 4 current from each power supply. When alternating current is applied, the circuitry automatically isolates the batteries from the circuit until the alternating current supply is removed.

A +5V switcher 8 is used to provide +5V power to a fingerprint module 10 and an unlocking motor control unit 12. This supply is enabled or disabled by a central processing unit 16 which is programmed to control all functions on a control board. The output is preferably +5Volts, at 500 mA, and a 2.7-5.0 volt input range.

A +3.3V switcher 14 is used to provide power to the microcontroller 16, a RS-232 level converter and a finger presence detection circuitry 18. The finger presence detector 20 is preferably an infrared detector which measures the transmission and reflection of infrared light, but may also be in the form of a micro-switch positioned near the fingerprint sensor 10. The output of the switcher 14 is specified at +3.3V, at 50 mA, and a 2.7-5 Volt input range.

The main central processing unit (“CPU”) 16 is preferably a Texas Instruments™ MSP430 family microcontroller. This device acts as a controller for all of the devices on the board. It monitors the circuitry, communicates with the fingerprint reader 10 and implements all enrollment processes for enablement of a fingerprint code. The CPU 16 controls the power going to all devices on the board. In a standby mode, the CPU 16 is in a sleep phase drawing minimal current for versatile use of the biometric lock in either fixture or portable applications. Approximately four times per second, the CPU 16 wakes up and powers up the finger presence detector 10 and then turns it off again. When a finger is detected, the CPU 16 powers up the +5Volt switcher 8, the fingerprint sensor module 10 and the motor control unit 12. After the motor 24 has cycled, the CPU 16 shuts down the entire system and returns to sleep mode.

An enrollment button (not shown) is preferably positioned on the board and is used to enroll an enabled fingerprint for verification with an offered fingerprint. When the enrollment button is pushed, the CPU 16 powers up the +5Volt switcher 18, the fingerprint module 10, and an RS-232 level converter to enroll an enabled fingerprint.

In a preferred embodiment of the locking system, the fingerprint presence detector 18 is an infrared reflective object sensor which detects the presence of a finger placed proximate to the fingerprint sensor 20. This device is mounted near the base of the fingerprint detector 18 in a “looking up” configuration. This device transmits infrared light for detection by its infrared receiver which is mounted next to the transmitter. Once a finger is placed close to the sensor 20, infrared light is reflected from the finger to the receiver resulting in a signal being sent back to the CPU 16. The CPU 16 then powers the fingerprint detector 22 at a rate of approximately four times per second.

The unlocking mechanism includes a motor driven cam shaft connected to the motor 24 with a cam aligned to pass over the controller board. The cam includes a small magnet mounted on it. A magnetic sensor is also mounted on the board in circumferential alignment with the magnet so that the magnet passes over the sensor upon rotation of the cam. When the magnet is aligned with the sensor, it sends a positive signal to the CPU 16 which indicates the exact angular rotation of the motor shaft.

A capacitive-based fingerprint sensor and module, such as the one marketed under the trademark Sagem Morphomodule, Sagem S.A., is preferred and requires RS-232 levels. A device which will generate these levels from the +3.3V power supply is positioned on the board to provide communication between the fingerprint module 10 and the CPU 16.

A buzzer or LED light may, but need not, be mounted on the board to provide the user with audible or visual prompts throughout the enrollment process, the enabled fingerprint removal process, and to provide a low battery indication.

The microcontroller 16 implements all functions on the board. The microcontroller 16 is used to perform fingerprint enrollment, fingerprint verification, enabled fingerprint removal, and power management. The program is stored in flash memory and is coded in the C programming language. Table 1 below lists and describes the inputs/outputs for the microcontroller 16.

TABLE 1

| Function | Input/output | Description |
|---|---|---|
| Motor Excitation | O | Controls a Field Effect |
| | | Transistor that switches |
| | | power to the motor. |
| Motor Position | I | A hall effect sensor gives an |
| | | active signal when the |
| | | motor completes on |
| | | revolution. |
| +5 V Enable | O | Controls a FET which turns |
| | | on the 5 V supply |
| Fingerprint Sensor Enable | O | Controls a FET that |
| | | switches power to the |
| | | fingerprint sensor. |
| Finger Detect Enable | O | Controls a FET that |
| | | switches power to the finger |
| | | detect circuitry. |
| Buzzer | O | Drives the buzzer for user |
| | | prompts |
| Wall Power | I | Feedback from the 5 V |
| | | switcher indicating that the |
| | | voltage has reached full |
| | | value. |
| RX | I | Serial communication from |
| | | the fingerprint reader. |
| TX | O | Serial communication to the |
| | | fingerprint reader. |
| Vbatt | I (Analog) | Port which monitors the |
| | | battery voltage for low |
| | | battery. |
| Pushbuttom | I | Pushbutton used to start the |
| | | enrollment sequences. |

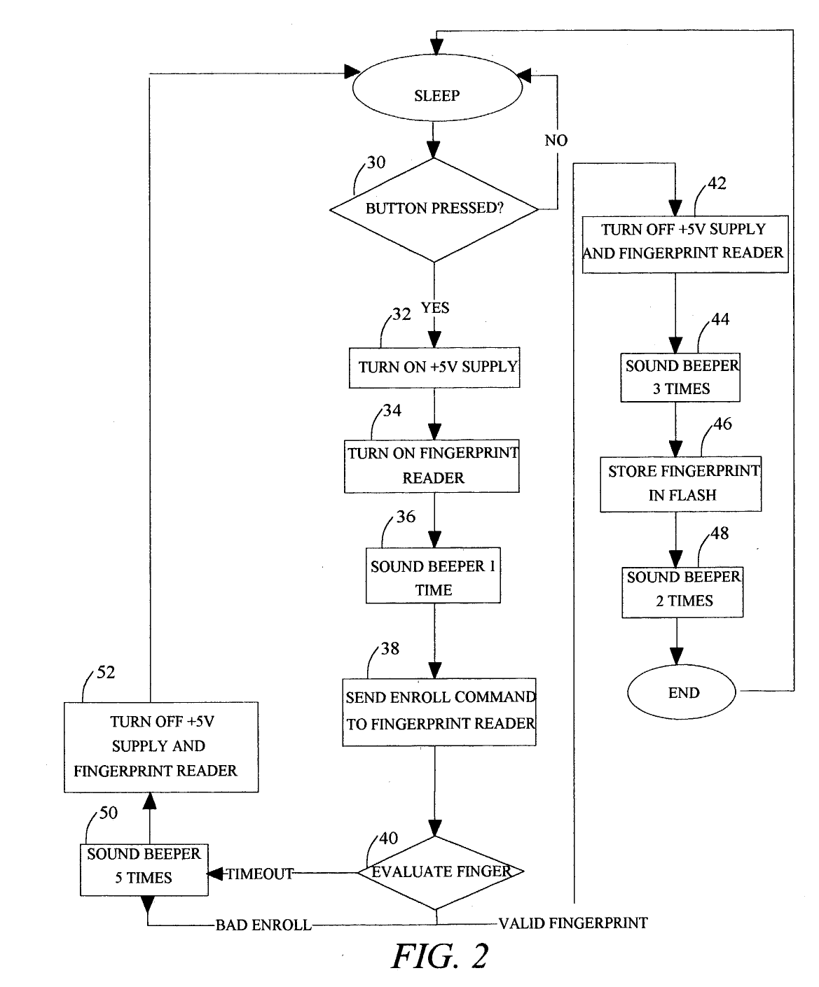

FIG. 2 illustrates the program logic flow for a single sample fingerprint enrollment. Here, the user first presses 30 the push-button on the board. This action wakes up 32 the CPU, turns on the fingerprint reader 34 and sounds the beeper for a single beep 36. The CPU enables power to the fingerprint reader and engages 38 it into an enroll mode 40. After five seconds, the CPU preferably turns off 42 the +5V supply and fingerprint reader, and beeps 44 the buzzer three times to indicate a valid fingerprint read, or five times 50 to indicate an invalid fingerprint. Another two beeps 48 are indicated, where a valid condition has been evaluated 40, to indicate to the user that the now enabled fingerprint has been successfully stored in a flash memory 46. The user may now unlock the lock by placing their offered fingerprint on the fingerprint sensor. Where the evaluation step 40 results in a bad enroll, the CPU sounds 50 the buzzer 5 times and turns off 52 the +5V power supply and fingerprint reader.

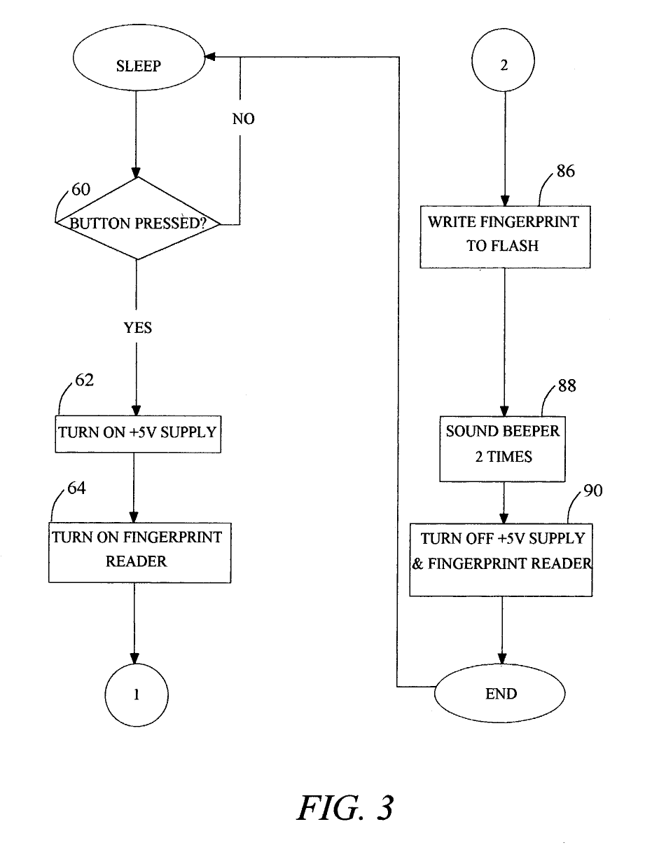

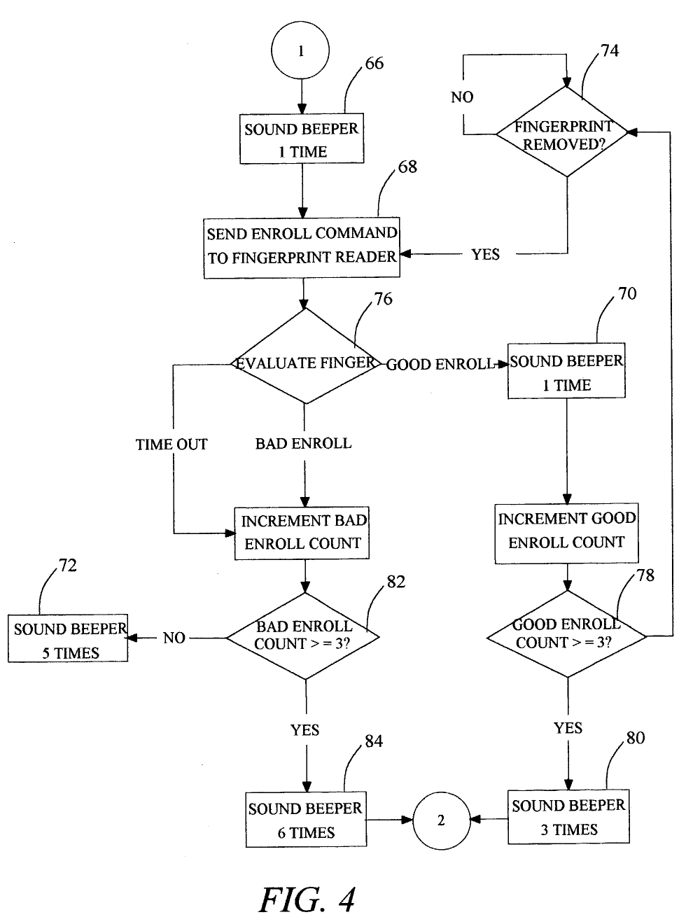

FIGS. 3, and 4 show an alternative program logic flow for an even more secure enrollment method of an enabled fingerprint. Here, in a three sample enrollment method, the user presses 60 the push-button on the board which wakes up the CPU, turns on the +5V power supply 62, turns on 64 the fingerprint reader, and operates the buzzer 66 for a single beep (FIG. 4). The CPU enables power to the fingerprint reader and, as described above, puts it into an enroll mode 68, signaled with a single beep. Within five seconds, the CPU will beep the buzzer 70 a single time for a valid fingerprint or five times 72 for an invalid fingerprint. For a valid fingerprint, the controller waits for the user to remove their finger 74. The user must then place their finger 76 on the sensor a second time and repeat the above sequence. Once three successful samples have been taken 78 the CPU will sound 80 the signal three beeps. The CPU does not accept three invalid fingerprints 78, 82, throughout this sequence, before signaling 84 a beep six times to indicate that the user must press the push-button and start the sequence over. For the valid condition, the enabled fingerprint data are written into the flash memory 86, another two beeps are signaled 88 after the new fingerprint has been successfully stored in the flash memory, and the +5V power supply and fingerprint reader are turned off 90 (FIG. 3). The user may now open the safe by placing their offered fingerprint on the finger print sensor.

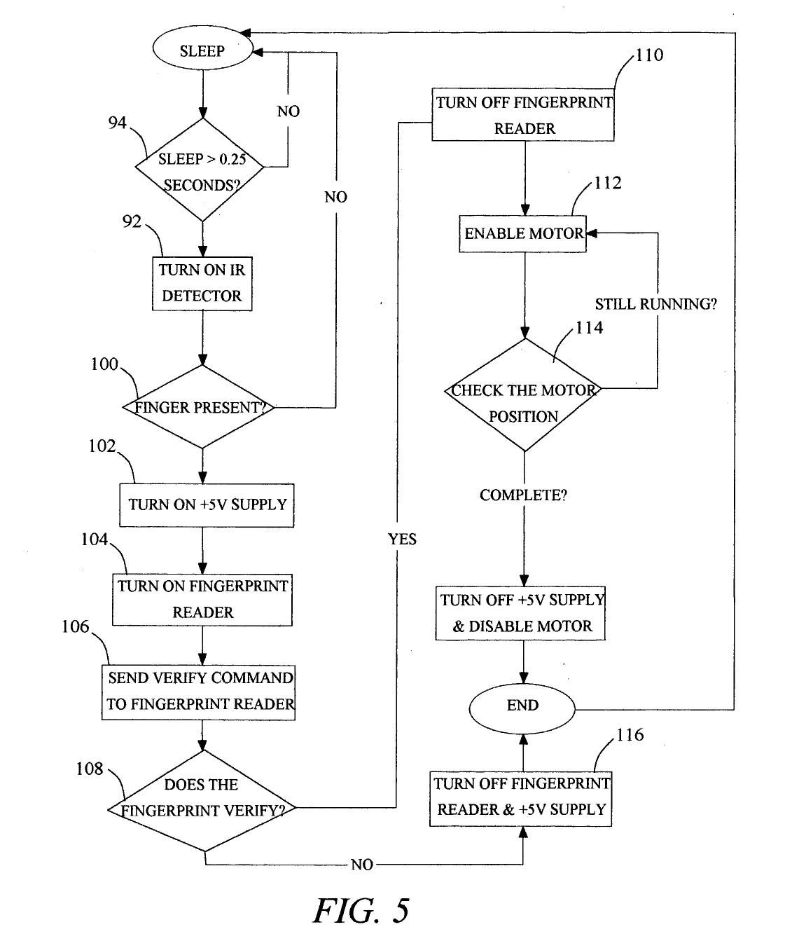

Referring now to FIG. 5, where it is shown the program logic flow of the fingerprint verification method, the finger presence detection circuitry is preferably turned on 92 approximately four times a second 94 for detecting 100 the presence of an offered finger. Once an offered finger is detected, the CPU powers up 102 the fingerprint sensor 104 and enables it 106 into a verify mode 108. When the offered finger print data match an enabled finger print data the fingerprint reader is powered off 110, and the CPU, which enables power 112 to the motor control unit, drives the motor until a Hall Effects sensor indicates 114 that the motor has completed its rotational travel. When an invalid fingerprint is indicated, the CPU signals the reader to turn off 116 the fingerprint reader and the +5V power supply ending the verification method.

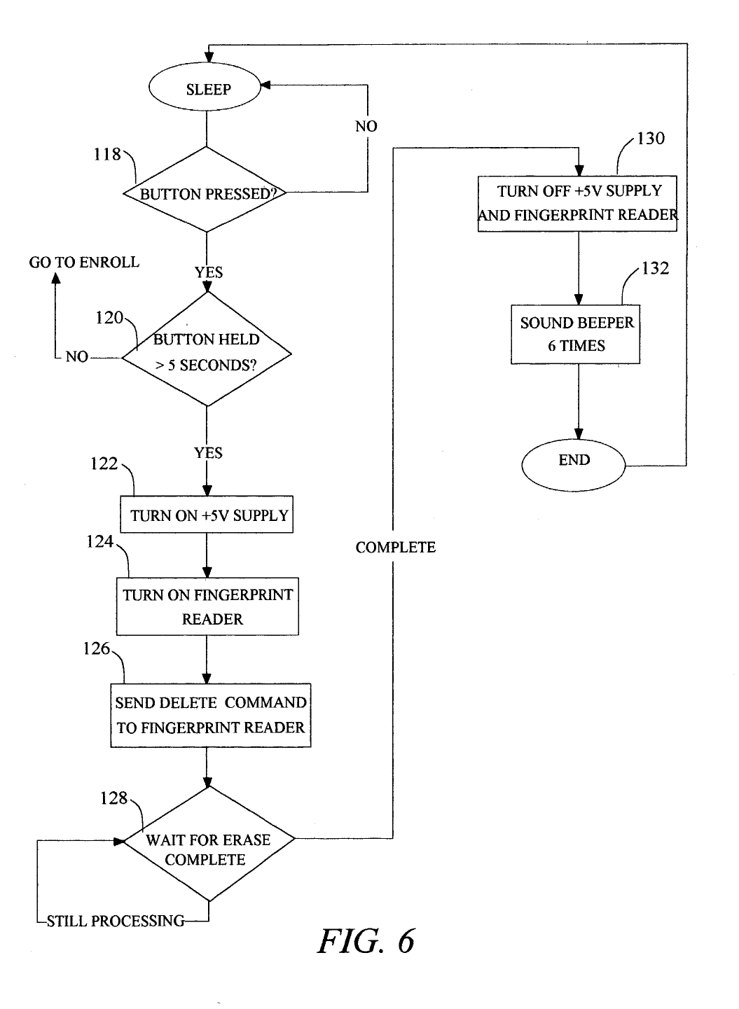

FIG. 6 shows the program logic for removal of an enrolled fingerprint from the flash memory. To remove or erase all enrolled fingerprints from the fingerprint reader the user must press 118 the push button and hold 120 it for five seconds. If so, the CPU turns on the +5V power supply 122, turns on the fingerprint reader 124, and sends 126 a delete command to the fingerprint reader. When all enrolled fingerprint data have been erased 128 from the flash memory, the CPU turns off 130 the +5V power supply and the fingerprint reader, and sounds six times 132 to indicate deletion of the data.

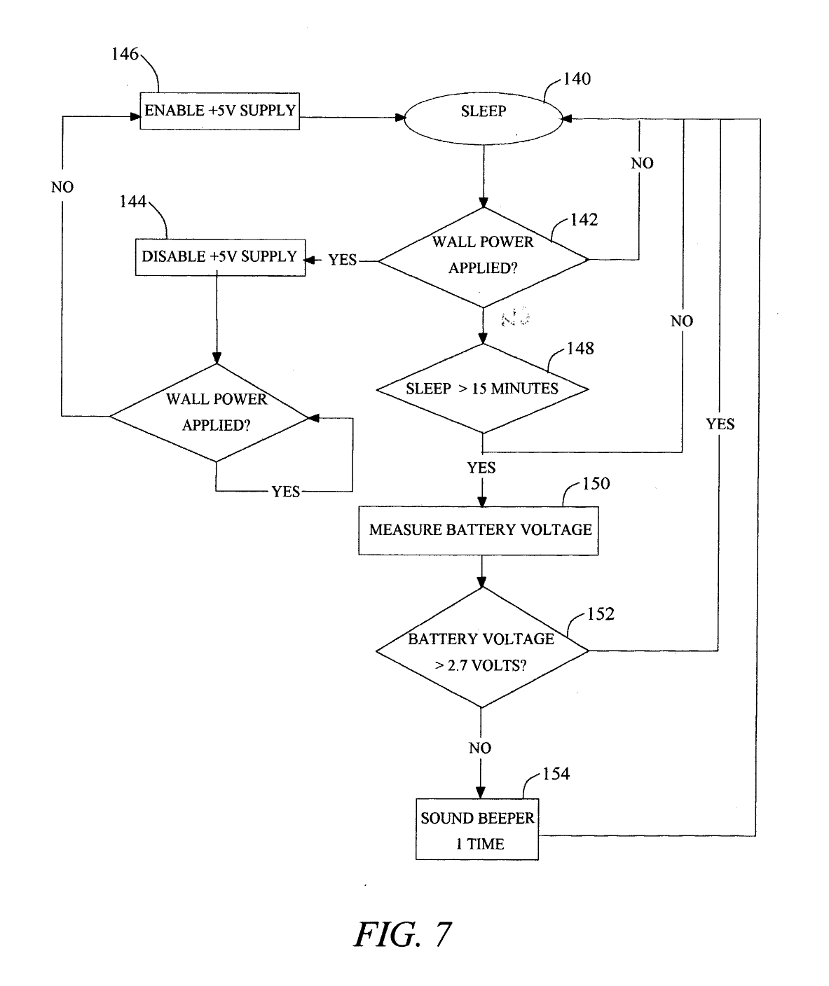

FIG. 7 shows the program logic for power management system. The CPU controls all power management functions on the board and begins in a sleep mode 140. It then determines whether wall power is applied 142, and, if so, disables the +5V power supply 144. If wall power is not applied, it enables the +5V power supply 146, wakes up every fifteen minutes 148 and measures 150 the battery voltage, and determines 152 whether the battery voltage has fallen below 2.7 Volts. If the battery voltage is less than 2.7 Volts the CPU goes back into the sleep mode, and sounds 154 the beeper once every fifteen minutes.

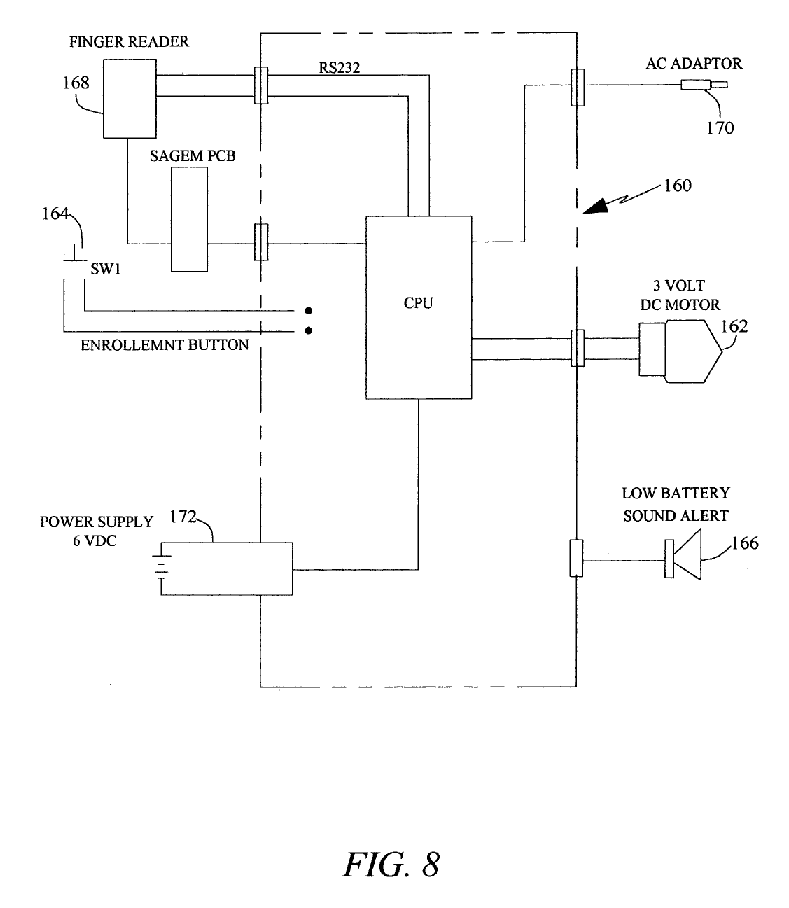

FIG. 8 is a schematic diagram of the personality board the motor control circuit. In the preferred embodiment, the controller board 160 is preferably mounted directly to the motor 162, but may also be used to control a stepper motor, solenoid or magnetic release. A Hall Effects sensor is mounted in a position that can monitor the magnet attached to the cam on the +3V DC motor. The enrollment push button 164 and buzzer 166 are also mounted directly to the board 160. The finger print presence detector (not shown), alternating current adapter connector 170, 6V DC power supply 172, and fingerprint reader 168 are all connected through the board via a wiring harness in any manner well known in the art.

### EXAMPLE

The following example describes use of the fingerprint biometric lock for use in unlocking a portable gun safe.

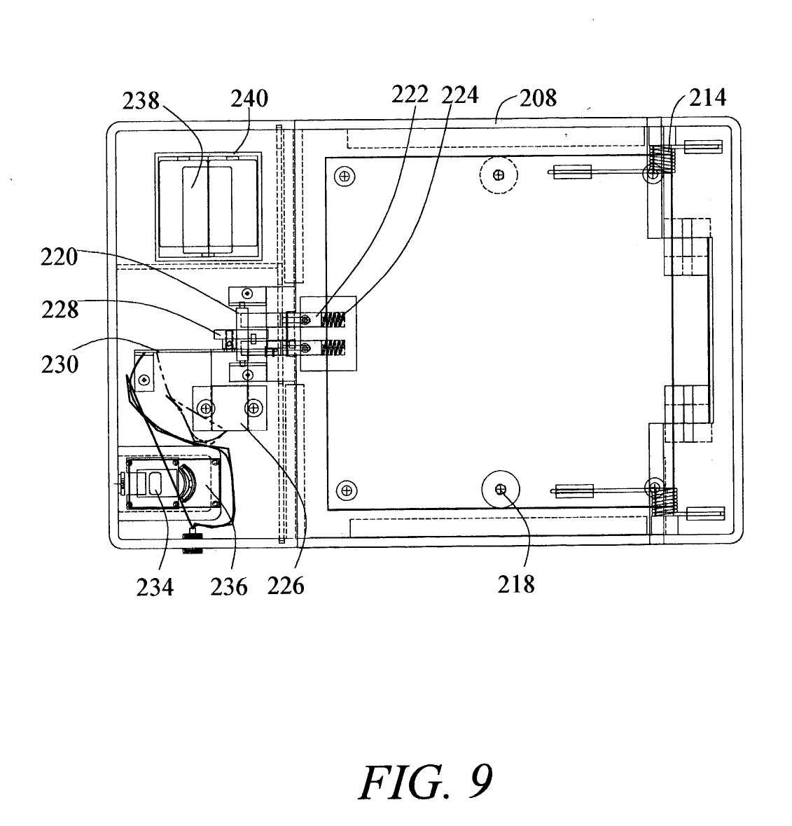

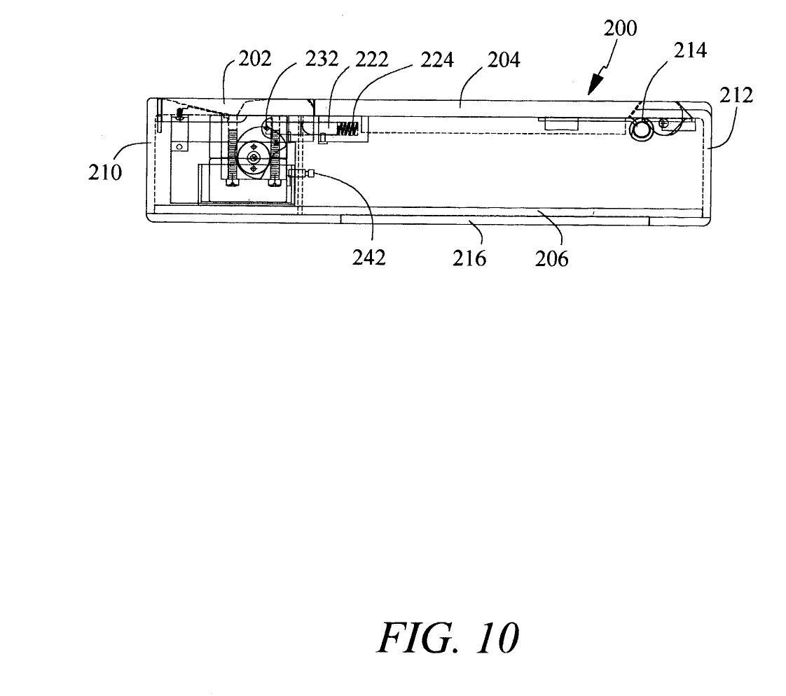

Referring now to FIGS. 9 and 10, wherein like numerals represent like features there is shown generally therein a high security portable gun safe unit 200 for use with the biometric lock as its single means of entry. The gun safe 200 includes a top wall 202 having a hinged door 204, a bottom wall 206, side walls 208, a front wall 210 and a back wall 212. The top wall 202 is hinged with torsion springs 214 for spring loaded opening of the hinged door 204 when unlocked. The bottom wall 206 includes a mounting plate 216 secured with mounting screws 218 for secured attachment of the safe 200 to immobile objects when used in fixture applications. Also included is the above described electronic circuit that restricts the unlocking of the locking mechanism. The locking mechanism includes a latch opener 220 biasing against one or more sliding bolts 222 and compression springs 224 driven by a motor 226 driven cam 228 that secure the hinged door 204 in a locked position (as shown). The motor control unit includes the motor driven cam shaft with the cam 228 aligned to pass over the controller board 230. The cam 228 includes small magnet 232 mounted on it. A magnetic sensor is mounted on the board 230 in a position adjacent to the magnet 232 such that as the magnet passes over the sensor it sends a positive signal to the CPU for indication of the exact angle of the shaft.

In the preferred embodiment, the fingerprint sensor is a capacitive-based fingerprint sensor 234, and is wired through a slit opening in the exterior of the safe's top wall 202 for detection of an offered fingerprint. The fingerprint sensor 234 is connected to a scanning module 236 connected directly below the sensor to the interior of the safe. In combination, the sensor 234 and module 236 are used to detect and process the presence of a fingerprint. This fingerprint scanning module 236 provides for enrollment of one or more digital fingerprint template data for entry into the flash memory of the fingerprint scanning module, as an enabled user. The module 236 is also used for verification of enrolled users and signals the electronic movement restricting circuit upon verification of an enrolled user. Three D-Cells 238 are contained in a conventional battery holder 240 and are used to provide a direct current to the power management circuit which, in turn, provides power to the locking mechanism and the fingerprint reader.

The safe is preferably constructed of 18 gauge steel on each side, top, bottom and door but may be constructed of any tamper resistant material, such as any high impact or ballistic material which are well known in the art. The top wall 202 steel has been formed such that the door 204 is offset to the inside by one-half inch to discourage prying of the door 204. The door 204 is spring loaded for immediate access to the interior of the safe 200 upon opening of the unlocking mechanism. The position of the hinge can be moved depending upon the desired application. A double bolt system 222 is used in latching the door 204 in a closed position and is controlled by a servo motor 226. A slot extends top middle of the top wall for the wires from the fingerprint reader to connect to a relay board located on the inside top middle of the door.

The locking mechanism is located on the inside of the door. This mechanism includes the servo motor 226 that moves the two locking bolts 222 in and out of aligned recesses in the hinged panel 204. The motor 226 is activated by a relay movement restriction circuit attached to the fingerprint reader board 236. When a finger is placed on the reader 234 and verified as an enrolled user, the board sends a signal to the relay which in turn allows electricity to be sent to the motor 226. This electric signal will drive the motor 226 to rotate the cam 228 away from the bolts 222 whereby the springs 224, normally compressed when the door is latched, expand and move the bolts 222 outwardly from the latch recesses for unlocking the door.

In operation, one uses the gun safe to secure items in a highly secure but rapidly accessible manner. Mounted on the inside of the safe is the enrollment button 242 which operates, as described above, in either a one or three step enrollment sequence, for enrolling a fingerprint data into the flash memory of the fingerprint module. The whole fingerprint is not stored, but an algorithm is used to determine minutiae points from the fingerprint points, of the fingerprint, and stores them as a template in the flash memory. Once the template has been stored, the enabled fingerprint is now the exclusive means of gaining entry to the safe. In this mode, the enrollee simply places their offered finger on the fingerprint reader and, once it has been verified as an enabled fingerprint, the verification unit sends a signal to the relay. The relay then allows electricity to flow to the motor that drives the locking bolts outwardly.

While the present invention has been described in connection with the illustrated embodiments, it will be appreciated and understood that modifications may be made without departing from the true spirit and scope of the invention.

I claim:

1. A fingerprint biometric lock, comprising:
(a) a locking mechanism means that restricts the movement of an object that is to be unlocked;
(b) a movement restriction electronic circuit that restricts the unlocking of the object by the locking mechanism;
(c) a fingerprint sensor that detects a fingerprint pattern;
(e) a memory device that stores an enrolled fingerprint code data;
(f) a verifying unit that determines whether an offered fingerprint code, created from the fingerprint pattern sensed by the sensor, matches with any of the enrolled fingerprint codes stored in the memory device;
(g) a motor control means that unlocks the locking mechanism through the movement restricting electronic circuit, when the offered and enrolled fingerprint codes match; and
(h) a finger presence detector for powering a direct current to the sensor and the motor control unit.

2. The fingerprint biometric lock according to claim 1, wherein proximity detector transmits or receives a beam of light.

3. The fingerprint biometric lock according to claim 1 wherein the proximity detector is a micro-switch.

4. The fingerprint biometric lock according to claim 1 wherein the fingerprint sensor is capacitative-based.

5. The fingerprint biometric lock according to claim 1, further comprising a high security portable storage unit having two sides, a front, a back, a top and a bottom walls, at least one of the walls having a hinged panel for access to an interior of the unit when the locking mechanism unlocks the hinged panel.

6. The fingerprint biometric lock according to claim 5 wherein the high security portable storage unit is a gun safe.

7. The fingerprint biometric lock according to claim 6 wherein the control unit further comprises a servo motor having a shaft for driving a cam and a controller board, the cam including a magnet in substantial alignment with a magnetic sensor on the controller board for outputting a signal indicating a rotation of the shaft.

8. A method for unlocking an object in a secured storage, comprising the steps of:
(a) storing in a first memory means a power management sequence data;
(b) inputting in a second memory means finger detection data;
(c) using the first and second memory means to enroll an enabled finger print code;
(d) using the first and second memory means to sense an offered finger print code;
(e) determining whether the offered fingerprint code data verifies with the enabled fingerprint code; and
(f) outputting to a motor control unit a signal for unlocking a locking mechanism when the offered and a registered fingerprint codes match.
